(19) United States
(12) Patent Application Publication
(10) Pub. No.: US 2006/0150087 A1
(43) Pub. Date: Jul. 6, 2006

(54) Ultralink text analysis tool

(76) Inventors: Daniel Cronenberger, Kingersheim (FR); Nicolas Grandjean, Mulhouse (FR); Olivier Kreim, Bruebach (FR); Patrick Mevel, Zaessingue (FR); Pierre Parisot, Mulhouse (FR); Manuel C. Peitsch, Allschwil (CH); Martin Romacker, Lorrach (DE); Therese Vachon, Pfastatt (FR)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 11/337,140

(22) Filed: Jan. 20, 2006

(51) Int. Cl. G06F 17/21

(52) U.S. Cl. 715/513

(57) ABSTRACT

The invention is a computer implemented method that allows a user to search a text for specific words (e.g. words found in a user-defined library), visually identify any such words found in the text, and have at their fingertips a utility for further exploration of each identified word. The utility, sometimes herein called an ultralink utility, allows a wide variety of options for further exploration of the identified word. The user thereby saves time in explorations; in addition the utility can assist in directing the user to inquiries which may be important for the user.

### BACKGROUND OF THE INVENTION

Exploration of a text is a literary technique which is now substantially aided by computers. Computers now supplement traditional library based book learning to give the user rapid access to secondary sources which help the user understand the text. Computers are able to access vast secondary sources of interest to the user either from databases stored in the computer, databases available to the computer through local networks, and databases publicly available over the internet.

A specific example of computer assisted exploration of a text is hyperlinking. Generally, a hyperlink is an element in an electronic document that links to another location in the same document or to an entirely different document. Typically, you click on the hyperlink to follow the link to the next location. Hyperlinks are an essential ingredient of hypertext systems, such as the World Wide Web.

Hyperlinking and improvements to it are described in published US Patent Application Publication No. US20040205514A1 incorporated herein by reference. In a common scenario, a user accesses a web page that includes multiple hyperlinks. For example, a user may access a text, such as a web search results page, having multiple links to resources identified by a web search engine. In order to view the resource associated with a hyperlink, the user must select the hyperlink which causes the browser to retrieve the resource and display it.

Hyperlinking in this fashion directs a user to one specific resource. It is an embedded link that is provided with the text.

A flexible hyperlinking system is described in WO9724684 A1. In this disclosure, the user is invited to select a word from a text using an input device, and the computer then performs an action with the word. While this is not an embedded link, the link directs the user to one specific action, i.e. there is no list of options provided to the user.

Other references in the general art field of this invention include cursor display technology in U.S. Pat. No. 6,281,879, and text formatting technology disclosed in U.S. Pat. No. 6,886,133, both incorporated herein by reference.

The inventors have recognized that the art provides only limited tools for user directed exploration of text pages. These generally comprise fixed links to specific secondary source documents or actions which may not be of significant interest to the user. It is an object of the invention to greatly facilitate exploration of texts by providing users a wide range of options which are useful to explore, investigate or study words in a text.

### SUMMARY OF THE INVENTION

The present invention allows a user to search a text for specific words (e.g. words found in a user-defined library), visually identify any such words found in the text, and have at their fingertips a utility for further exploration of each identified word. The utility, sometimes herein called an ultralink utility, allows a wide variety of options for further exploration of the identified word. The user thereby saves time in explorations; in addition the utility can assist in directing the user to inquiries which may be important for the user.

The invention therefore relates to a computer implemented method for exploring a word in a text comprising:
a) displaying a text on a computer display device,
b) responding to a user invocation event by identifying one or more words which are present in the text, from a user-defined library, thereby generating one or more identified words,
c) associating a utility with each identified word, wherein the utility provides the user with a list of two or more options for further exploration of the identified word based on a concept type associated with the identified word; and
d) displaying the text on the computer display device with the utility in visual association with each identified word.

In one embodiment the computer display device is a video monitor. Typically, user invocation events are selected from among clicking on a request button in a navigation bar, clicking on an icon elsewhere on the computer display device, touching an icon on a touch-sensitive screen, a mouse click, a mouse action, a keyboard input and any combination thereof.

In another embodiment at least two identified words are generated which are then displayed in association with an ultralink utility. This embodiment may arise when the user-defined library comprises at least two different words.

The ultralink utility may be either a visual icon adjacent to the identified word or it may employ textual highlighting of the word. In some cases, a different colour of textual highlighting will be employed for identified words of different concept types.

The list of two or more options provided by the ultralink utility may be selected from among Search Options and Analytical Options. The options provided by the ultralink utility are based on a concept type associated with the identified word. The concept type is a broad classification of the identified word (e.g. aspirin is a ‘drug’; Bayer is a ‘company’). In cases where there is more than one concept type associated with the identified word, activation of the ultralink utility may be preceded by a request to the user to select the concept type prior to providing the list of two or more options. The list of two or more options is typically displayed in response to a second user invocation event. Such list may optionally appear in a separate window.

The user has the choice to select one or more of the options presented by the ultralink utility, and the choice may be activated by a third user invocation event. The results of the option activated by the third user invocation event are typically displayed in a separate window for convenient viewing and access.

In an embodiment of the method of the invention, the computer executes the steps of generating one or more identified words and associating with each identified word a utility by:

sending the text to a lexical analysis server comprising a user-defined library,
wherein the lexical analysis server:
   compares each word in the text against the user-defined library,
   tags words in the text also found in the user-defined library, to generate tagged words,
   returns tagged words to the computer,

receiving the tagged word from the lexical analysis server, and

modifying the text on the computer display device to visually associate the utility with every occurrence of each tagged word.

A physical embodiment of the invention may comprise a computer readable medium encoding a computer program for executing on a computer system a computer process for exploring one or more words in a text according to the method of the invention. The various sub-methods and variations of the method described above may be directed by the program contained on the computer readable medium.

In another embodiment, the invention comprises means for implementing the method of the invention using means disclosed in this specification.

Further embodiments of the invention are described herein and fall within the scope of the appended claims.

### BRIEF DESCRIPTION OF THE DRAWINGS

FIG. 1: Description of the ultralink text analysis tool with major steps and certain sub-steps illustrated.

FIG. 2: A typical web page suitable for application of ultralink text analysis.

FIG. 3: Typical web page highlighting tool 301 to request ultralink anlaysis.

FIG. 4: Typical web page generated in response to a request for ultralink analysis, with examples of identified words displayed in association with the ultralink utility 401.

FIG. 5: Typical web page with optional ultralink utility formatting 501 which may be provided to assist user in consideration of whether or not to activate the ultralink utility for a specific identified word.

FIG. 6: Results observed on a typical web page upon activation of ultralink, in this case by mouse click on the identified word. New window 601 is presented with list of two or more options for further exploration of the identified word.

### DESCRIPTION OF THE INVENTION

Embodiments of the present invention allow a user to search a text for specific words (e.g. words found in a user-defined library), visually identify any such words found in the text, and have at their fingertips a utility for further exploration of each identified word. The utility, sometimes herein called an ultralink utility, allows a wide variety of options for further exploration of the word. The user thereby saves time in explorations; in addition the utility can assist in directing the user to inquiries which may be important for the user.

A short general overview of the invention is as follows.

The user-defined library is a pre-determined list of words which are relevant to the field of study, exploration, inquiry, or investigation of the user. A user can create such a library by him/herself, or may use the library of an associated organization (such as a university department or corporation). Libraries of words can be assembled for explorations of any topic, including but not limited to any academic discipline, industry sector, entertainment preference, social, historical or cultural field.

The method of the invention searches a text of interest to the user for words from the user-defined library and tags the words in the text that are found in the library. A utility, sometimes called an ultralink utility, is then associated with tagged words in the text to create ‘identified words’. The ultralink utility is either a visual icon located proximal to an identified word or a textual highlighting of the identified word such that a user may easily locate the identified word and the utility that is associated with it.

A critical aspect of the ultralink utility is the set of two or more options that it offers to the user. The two or more options are selected from among two broad categories. The first category consists of options for searching the identified word in databases of interest to the user (herein ‘Search Options’). The databases may be public or private databases as defined by the user. Search Options will search for occurrences of the word in these other databases. The second category consists of options for analyzing the word (or more likely its underlying signifier) by applying a computational analysis of interest to the word (herein ‘Analytical Options’). The computational analysis options may be, for example, scientific, comparative, illustrative, or any other analysis usefully associated with the word.

The options offered are selected based on a concept type which is associated with each library word. The concept type is a categorization of the word based on the broad classification of the meaning of the word. For example, aspirin may have the concept type of ‘drug’. The ultralink utility may be designed to provide various options typically of interest for exploring a drug, including but not limited to exploring therapeutic dose, suppliers, or side-effects. The concept type will define the limited number of options that the user may logically seek to explore, inquire about or investigate regarding the identified word. In another example, if the identified word is ‘insulin’ and the concept type is ‘protein’, then one Analytical Option of interest might be to provide a visual representation of a three-dimensional image of the underlying signified protein.

In a useful embodiment, the list of concept types and the list of options associated with the concept type are provided by the user-defined library, and may conform to investigations normally of interest in his/her academic discipline, industry area, or field of endeavour.

The ultralink utility is then displayed on the text in visual association with the identified word. The user may choose to activate the ultralink utility or s/he may ignore the opportunity and move on to another document.

The utility thus offers to the user an option for convenient and quick directed inquiry into further explorations of the identified word. More details of the invention are described below.

Method of the Invention

The method of the invention relates to a computer implemented method for exploring a word in a text comprising:
a) displaying a text on a computer display device,
b) responding to a user invocation event by identifying one or more words which are present in the text, from a user-defined library, thereby generating one or more identified words,
c) associating a utility with each identified word, wherein the utility provides the user with a list of two or more options for further exploration of the identified word based on a concept type associated with the identified word; and
d) displaying the text on the computer display device with the utility in visual association with each identified word.

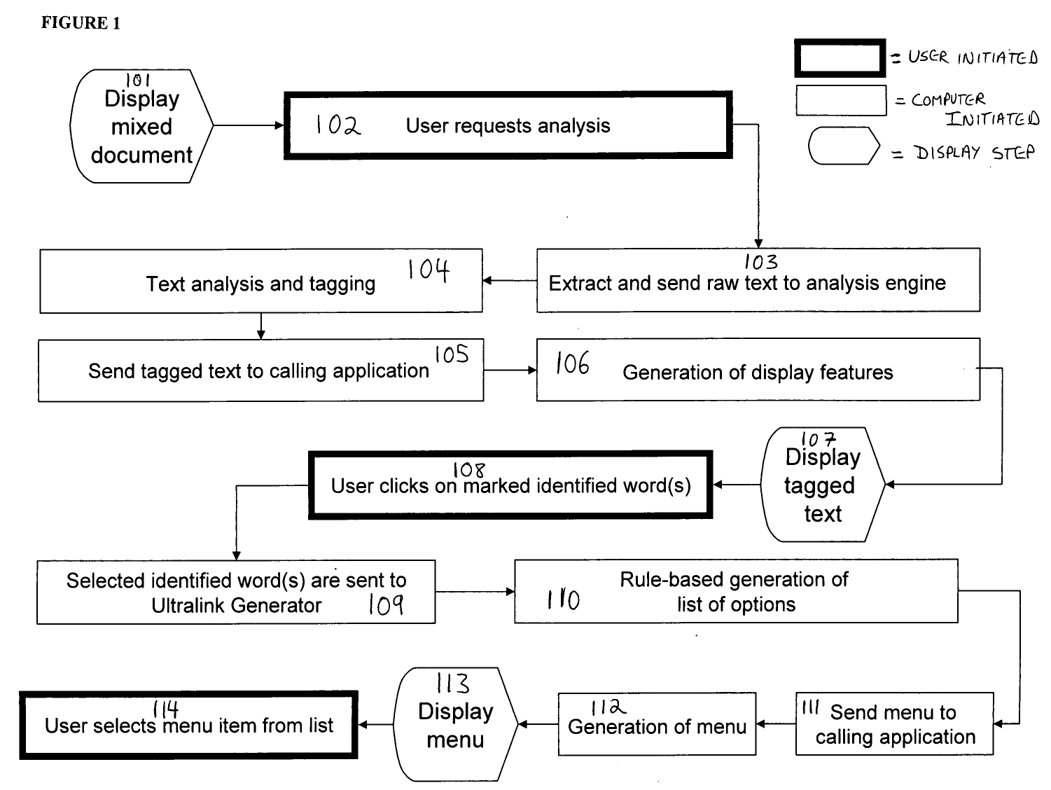

The steps can be described in relation to FIG. 1.

In FIG. 1, 101, a computer display device presents a document containing text which may or may not be mixed with other visual or graphical material. Typically this would be a web page or a document on a word processing application, but it may include any visual representation of text.

In 102, the user makes a request for analysis of the text. For the purpose of this specification, a request for analysis of the text is one of the ‘user invocation events’ employed with the invention. Such user invocation events include events that are initiated by an action of the user to invoke an activity of the computer. With current computer systems, a user invocation event is typically clicking on a request button in a navigation bar, clicking on an icon elsewhere on the computer display device, touching an icon on a touch-sensitive screen, a mouse click, a mouse action (such as dragging a cursor), a keyboard input, or any combination of these actions.

More specifically, request for analysis in 102, may happen through these events: (a) In the web browser or Adobe Acrobat: with a click on an icon in the tool bar that has been installed and added to the browser software (i.e. a new icon in Standard Buttons bar.); (b) In a specialized java application which can be loaded by the web browser to display text documents: a selection of a segment of text with the left mouse button followed by release of the mouse button; (c) In an application such as Microsoft Work, Excel and PowerPoint documents: A specialized application added to the MS Office environment to using technology similar to Smart Tags technology. This may include writing new text words, or pasting copied or cut text words.

Responding to the user invocation event, as illustrated in steps 103-107, the computer identifies one or more words which are present in the text, from a user-defined library, and generates one or more identified words that are presented for display on the computer display device in association with a utility.

More specifically, generation of identified words by a computer requires several sub-steps. It may be achieved as illustrated in FIG. 1, 103 by extracting the text portion of the document and sending the raw text to the analysis engine. The analysis engine, which may also be called the ‘lexical analysis server’ then performs the necessary functions in 104, namely it compares each word in the text against a user-defined library, it tags words in the text also found in the user-defined library, and in 105 it returns tagged words to the computer, more specifically the application from which the text was originally received (the ‘calling application’). The computer then generates display features 106, and transmits the text to the display device 107 for display with the utility in association with each identified word.

The user-defined library is determined in advance by the user. It may be assembled by him/herself, or it may be obtained from a supplier of such a library. Suppliers of such a library can be any academic organization, commercial vendor, industry organization, association, group or club sharing an interest in a common area. In the user-defined library, each word is associated with one or more concept types, as described further below. In a useful embodiment the user up-loads the preferred library before or at the time s/he invokes the ultralinker.

As used herein, a ‘word’ found in a user-defined library may be any ordinary word (which may or may not be found in a dictionary) which has an intelligible meaning; in addition, a ‘word’ may be any pattern of letters and/or numbers and/or symbols that is used to represent an intelligible concept or thing based on a rule. An example of the latter is a designation for a protein or nucleic acid which allows one to identify the protein or nucleic acid in a database. E.g. the UniProt database which uses an accession code comprising [OPQ][0-9][A-Z][A-Z][A-Z][0-9]. Rather than containing a list of all UniProt accession numbers, which must constantly be updated, the user-defined library can contain a tool that identifies for the user any pattern of letters/numbers/symbols that, based on rules, corresponds to a specific database. Thus ‘words’ that may be identified in the text include any such patterns that may be identified by rules contained in the user-defined library. Further examples include SwissProt (or any other database) accession codes which consist of a pattern of letters and numbers for which rules can be defined. Another example would be NP_numbers used in the RefSeq database with the rule that NP_means protein from RefSeq while if it is NM_numbers then it is a gene sequence (NMJ (XM_being a predicted gene).

It may be useful for the invention to include a thesaurus type function in the user-defined library. Thus an identified word can be linked to other, related words, for generation of concept type and other uses (as set out further below).

To be practical, the user-defined library is in a format where a computer application in 104 can extract each word and use it to search a text provided by the user. When a word match is identified, the computer application will tag the word and its location in the text. The tagged words are returned to the calling application.

Once the tagged words are received by the calling application, the calling application must generate display features (106) and display the tagged text (107) on the computer display device in a way that the user can visually identify the tagged text (i.e. the identified words). Typically, the identified words will be displayed in 107 either with a visual icon adjacent to the identified word (overlapping or concealing the word being a less desirable embodiment); or alternatively the tagging will employ textual highlighting of the identified word. Textual highlighting is well known in the art. It can take many forms, including bolding, underlining, changing font and the like. It may also include using a different colour for the lettering of the identified word or for the background page area immediately behind the identified word, thus contrasting with the rest of the text. As will be seen below, a useful embodiment of the invention is to employ a different colour of textual highlighting for identified words of different concept types.

In the method of the invention, the exploration of identified words is made particularly useful and convenient by visual association of a utility with each identified word.

For the purposes of this specification, a ‘utility’, sometimes herein called an ultralink utility, or ultralinker, is a tool that provides, at the request of the user, a list of two or more options for further exploration of the identified word based on a concept type pre-associated with the identified word. As such, ‘utility’ is a term of art known to those in the word processing field. The ultralink utility may be activated by a user invocation event, such as those suggested previously. Because the invention draws important value from the immediacy of the connection between the identified word and the tool, when displayed, the ultralink utility is visually closely associated with the identified word. In the simplest embodiment, the method used to visually tag the text will also provide the ultralink utility. For example, where an identified word is textually highlighted, the user may position a mouse directed cursor to hover over any portion of the highlighted text, and upon clicking the mouse, the user will activate the ultralink utility. Similarly a user may touch the identified word on a touch-sensitive screen to activate the ultralink utility. Alternatively, where a visual icon is employed to tag an identified word, the user may position the mouse directed cursor to hover over any portion of the icon, and upon clicking the mouse, the user will activate the ultralink utility.

Numerous options are available for activating the ultralink utility by the user. In some designs it may be preferred to have a multi-step process for activating an ultralink utility. For example, where a mouse directed cursor is positioned over a highlighted word, the highlighted word may change colour, or attract additional formatting changes, such as a box appearing around the word, underlining, bolding or the like. This allows the user to consider his or her decision to activate the ultralinker for that word prior to activating it. In some designs, the multi-step process will involve an inquiry to the user after a preliminary user invocation event, asking for input as to some aspect of the ultralink request. Whether single step or multi-step, the utility is activated by a user invocation event, and the result is that the user will be provided with a list of two or more options for further exploration of the identified word based on a concept type pre-associated with the identified word.

The underlying computer processes used to generate and present the options for further exploration of the identified word can be very diverse. In one example, illustrated in FIG. 1, 108, the user clicks on the identified word, and the selected word is directed to an ‘ultralink generator’ 109. The ultralink generator identifies the ‘concept type’ of the selected word and generates a list of options based on rules associated with the concept type 110. The list of options, is then sent as a menu to the calling application 111. The calling application formats and generates the menu 112, which formatted menu is then displayed on the computer display device for the user to see 113. For simplicity the menu will usually be displayed in a separate window or defined space on the computer display device so that the user can easily read and access the menu. Each one of the options provided on the menu by activating the ultralink utility may be activated by another user invocation event, according to the desires of the user.

Identification of the ‘concept type’ for an identified word is therefore a critical step for the method, because it is on this basis that the computer selects the options to be presented via the ultralink utility. For example the concept type ‘company’ may be associated with options that include exploring a wide variety of databases of company information (e.g. financial reports, stock charts, industry journals, newspapers, press releases, etc.) whereas the concept type ‘protein’ will be associated with options that include exploring databases for use in protein analysis (e.g. OMIM, GenBank, SwissProt, etc.).

Careful selection of the concept type(s) associated with an identified word makes the invention particularly useful. A good user-defined library will provide concept types that are meaningful and that will quickly lead the user on a path of exploration that is worthwhile. Concept types may be assigned directly in the user-defined library (one to one mapping); alternatively they may be assigned based on word ontologies as set out in Table 1.

TABLE 1
Term Lineage Graphical View (“Ontology”)

```
  all : all
    GO:0008150 : biological_process
      GO:0009987 : cellular process
        GO:0050875 : cellular physiological process
          GO:0008219 : cell death
            GO:0012501 : programmed cell death
              GO:0006915 : apoptosis
```

Table 1 identifies the term lineage, in graphical view, of a possible ontology for the word ‘apoptosis’. Line GO:0006915 identifies the word. Line GO:0012501 identifies an initial classification of apoptosis as a member of ‘programmed cell death’. Programmed cell death is a member of the ‘cell death’ class identified in GO:0008219. Cell death is a ‘cellular physiological process’ as per GO:0050875; and a cellular process is a ‘biological process’ as per GO:0008150. This hierarchical classification of words in an ontology is useful in creating rules for generating the options, as the rules are associated with the level of hierarchy of greatest relevance to the user. The rules are the same for all terms belonging to that concept.

Based on Table 1, the ‘concept type’ of the word ‘apoptosis’ could be selected from any of the classification levels of the ontology. The assignment of ‘concept type’ can usefully be assisted by considering the variety of options that might be presented to the user via the ultralink utility. The options useful for exploring ‘programmed cell death’ (line GO:0012501) are not, at this time, significantly different from those for exploring ‘cell death’ (line GO:0008219). The higher level of ‘Cellular physiological processes’ may lead to quite a few additional Search Options or Analytical Options. At some point the number of options is too large to be useful or provide quick assistance to the user. The concept type will therefore usually be chosen to be the level that provides the user with a set of options that can reasonably be explored. The set of options will be displayed in a menu as described above.

A more prosaic method to identify concept type is to simply to assign a single concept type to an identified word. The underlying computer process may simply bury or hide the specific the concept type in the visual tag associated with the identified word. When the user activates the ultralink utility, the computer directly requests the list of options associated with the concept type. This list of options is displayed in a menu as described above.

In some cases, more than one concept type may be associated with an identified word. This arises with a word that may fall under different broad categories of classification. The word ‘aspirin’ may fall under the concept type of PRODUCT (e.g. as an article of commerce), or as a COMPOUND (e.g. as a chemical compound), or as a DRUG (e.g. as a therapeutic agent). The user-defined library may associate all these and more concept types with the word ‘aspirin’.

In such cases, where there is more than one concept type, the ultralink utility may request the user to specify the concept type before providing the list of options. This is because the list of options and further inquiries will depend on the kind of exploration in which the user is engaged. This step may be added in addition to the other steps of the invention and would arise as an extra step between 108 and 109 in FIG. 1. Thus the list of options will correspond to the concept type selected by the user.

The ultralink utility is distinguished in several regards from a utility called Smart Tags provided in Microsoft Office XP®, which make it easier to complete some of the most common text based tasks. Smart Tags do not offer the options provided by the ultralink utility. For example, when you paste text into Microsoft Word, the formatting of the text might not be what is wanted in the Word document. In the past, you would have had to paste the text and then apply formatting styles to the new text by going to the Style box, scrolling down, and selecting the style to apply. Now, when you paste content into Word, the Paste Options button appears as a Smart Tag alongside the selected text that you have just pasted into your destination program. If you click on the Smart Tag utility, a small window opens which offers options, for example, the choice between keeping the source formatting or matching the destination formatting.

An important feature of the ultralink utility is that the list of two or more options is selected from among Search Options and Analytical Options. Search Options consist of options for searching the identified word in databases of interest to the concept type. The databases may be public or private databases as defined by the user. Search Options will search for occurrences of the word in these other databases. Many powerful searchable databases are available to specific fields of study. Private databases may be available only upon payment of subscription fees and with passwords. Not all such databases are useful for all fields. The invention provides a great benefit by directing the user to databases that will be of greatest interest to the concept type.

The Analytical Options are options for analyzing the word (or more likely its underlying signifier) by applying a computational analysis of interest to words of this concept type (herein ‘Analytical Options’). The computational analysis options associated with a concept type may be, for example, scientific, comparative, illustrative, or any other analysis usefully associated with the concept type. For example, if the identified word is ‘insulin’ and the concept type is ‘protein’, then one Analytical Option of interest might be to provide a visual representation of a three-dimensional image of the underlying signified protein. Another Analytical Option may be to compare the protein sequence to other protein sequences and present an alignment of the sequences. Another might be to count the number of amino acids in the protein or compute its hydrophobicity. Many kinds of analytical options are available in different fields of study.

The list of options is generated based on the ‘concept’ type as described above. The list can change over time as the availability of different options changes for the user. In one useful embodiment, the Ultralink will ask the target database of there is a document that makes sense for that term. If yes, then the Ultralink will offer a “Display Option” and the menu item will be created. Should the database answer “no—there is nothing in the database about this term” then the Ultralink will not create the menu item. This choice, to display or not display the option, can be made at the time of the user invocation event. It may not be technically possible to apply this inquiry for all databases.

The ultralink utility is also distinguished from the typical ‘hypertext’ utility, a commonly used computer assisted text exploration tool. The hypertext utility consists of a visual feature, generally a formatting change (e.g. an underline) or a colour change, or both, that appears in association with a word in a text. It is created in the source document and is not created as a result of a user invocation event. The ultralink utility of the invention is created in response to a user invocation event. Further, a hyperlink utility directs the user to one specific document which is specifically associated with the hyperlink utility. The hyperlink utility does not provide a list of options for the user to select among. The hyperlink utility is a fixed link to a specific document (e.g. Web Page) whereas the ultralink utility generates a list of options for further exploration of the identified word. The user is invited to select among the options provided by the ultralink utility to further explore the identified word.

It may also be noted that because the ultralink utility described herein is a text and word based tool, it does not at this time provide the utility in association with features visually identifiable from graphical representation.

The method of the invention can be applied in many fields. Some of the examples described herein relate to the kinds of text explorations that may be undertaken by users interested in the pharmaceutical industry, either as students, academics, employees of pharmaceutical companies, financial analysts of such companies, and the like. In such a case, the user will employ a user-defined library that contains words of interest to their endeavour, and the words will be categorized by concept types that lead the user to Search Options or Analytical Options for exploration of those words in relevant databases to which the user has access.

In another situation, a user interested in financial markets will employ the ultralink utility to explore financial information. The user-defined library will consist of terms relevant to the exploration, such as company names, stock symbols, specific securities and financial statistics. The concept types of these words will be selected such that they lead the user to a list of options commonly employed with words of that concept type. If the word is ‘General Electric’ the concept type may be ‘company’ and the options provided by the ultralink utility may include links to ‘product lines’, ‘stock price’, ‘locations’, ‘litigation’ or any other options defined by the user in advance.

In another situation, the user may be a patent examiner who is examining an electronic patent application. The patent examiner could invoke the ultralink utility to identify words in the text from his or her art field. The patent examiner could then activate the ultralink utility associated with an identified word to be presented with a list of options for further exploration of the word. The list of options will include options for prior art searching of the word (e.g. providing immediate access to specific databases), or it may include options to explore usage of a word in a particular field or industry.

Many other embodiments of the invention can be conceived based on the disclosure provided herein. All such embodiments fall under the scope of the claims appended hereto.

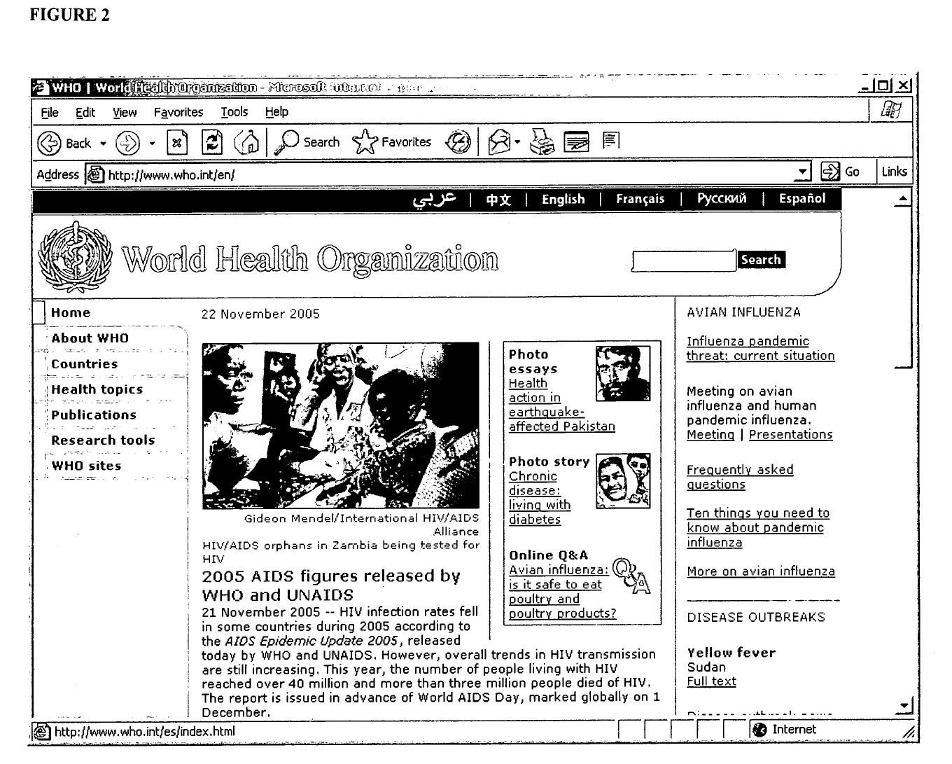

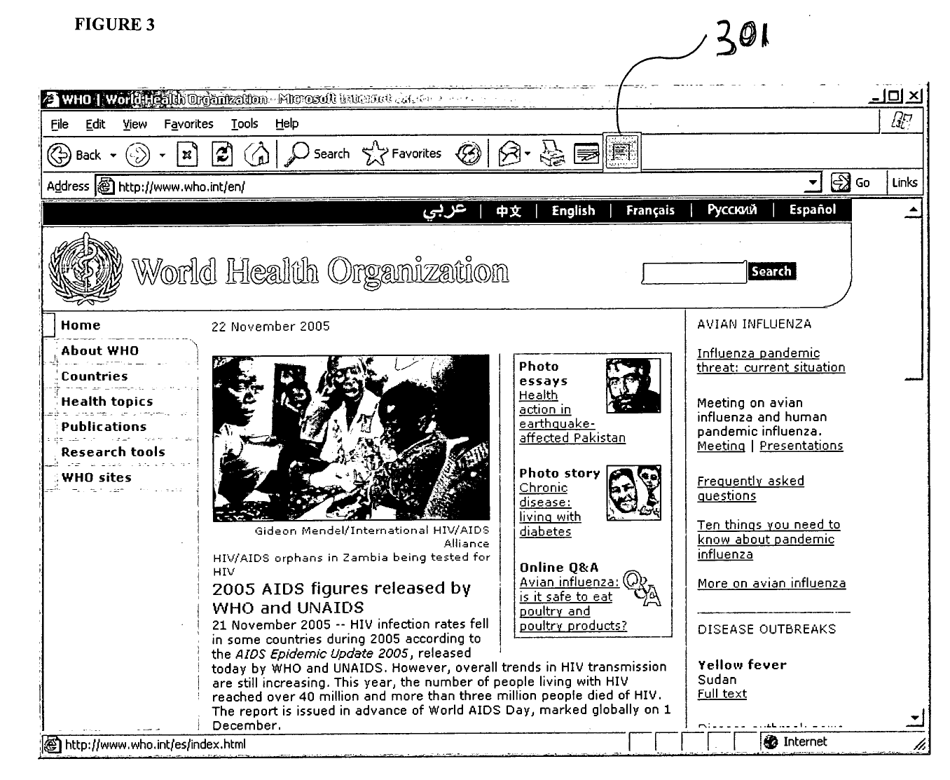

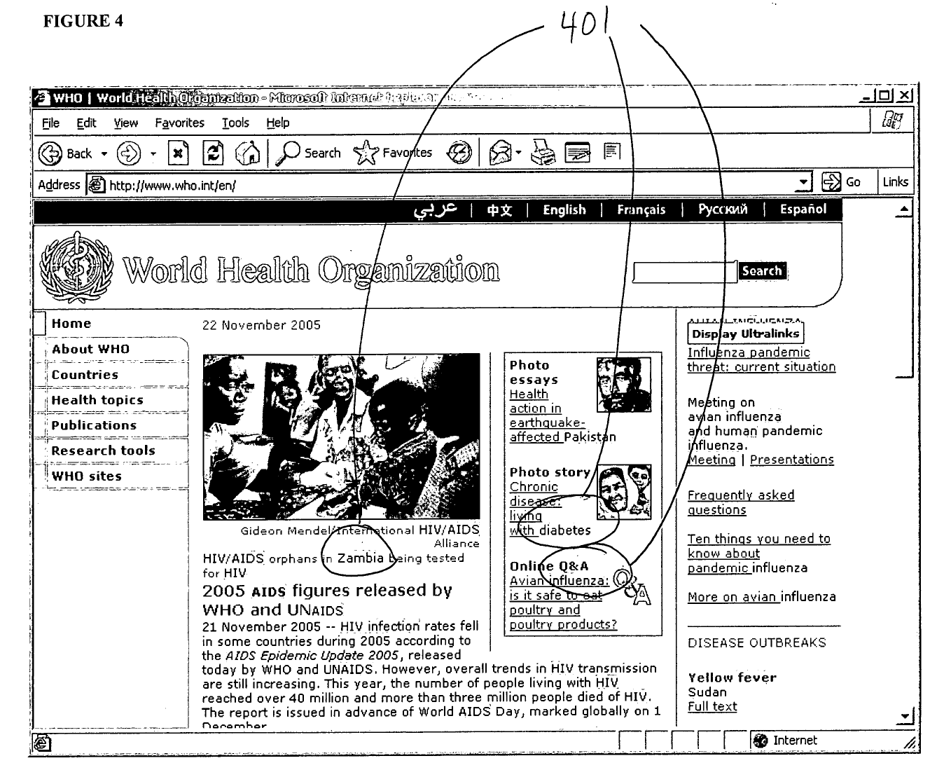

Implementation of the ultralink utility is illustrated in FIGS. 2-6. FIG. 2 illustrates a standard Web Page as presented on a video monitor by a computer. FIG. 3, 301, illustrates an icon situated in the navigation bar of a web browser that allows the user to initiate the request for analysis (i.e. request for generation of the ultralink utility). Responding to a user invocation event, such as using the mouse to position a cursor to hover over the icon, and clicking the mouse, the computer will initiate the steps of the method which will generate identified words (as described above). FIG. 4, illustrates the page of text now containing the ultralink utility 401 in association with identified words. In this case, the ultralink utility is visually displayed as contrasting background colour behind each identified word, and a slightly enhanced sharpness of font for the letters of the identified word itself. The identified words contrast with other text words for easy visual identification.

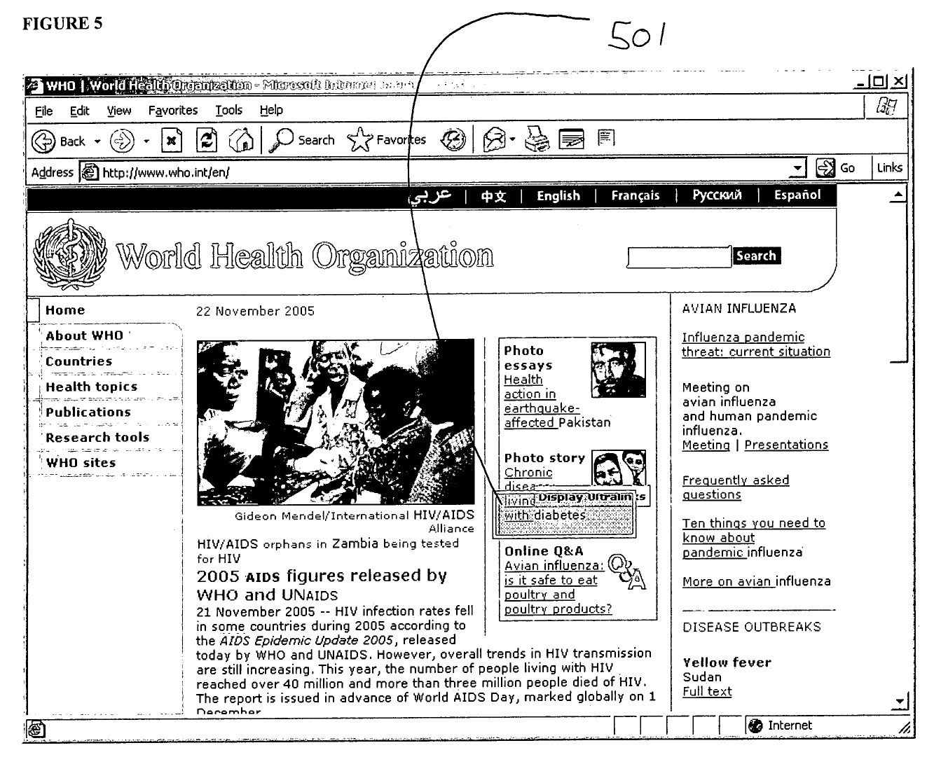

In FIG. 5, the user has positioned a cursor to hover over an identified word of interest. In this case, the identified word 501 is diabetes. As an optional feature of the invention, the computer has provided an additional highlighting box around the identified word so that the user may consider his/her selection of the identified word before activating the ultralinker. The additional highlighting may continue for the duration of the time the cursor is positioned over the identified word, or it may appear slightly after the positioning (e.g. 0.1 to 2.0 seconds after), or it may disappear after a suitable time (e.g. 2 to 10 seconds, or longer after initial display).

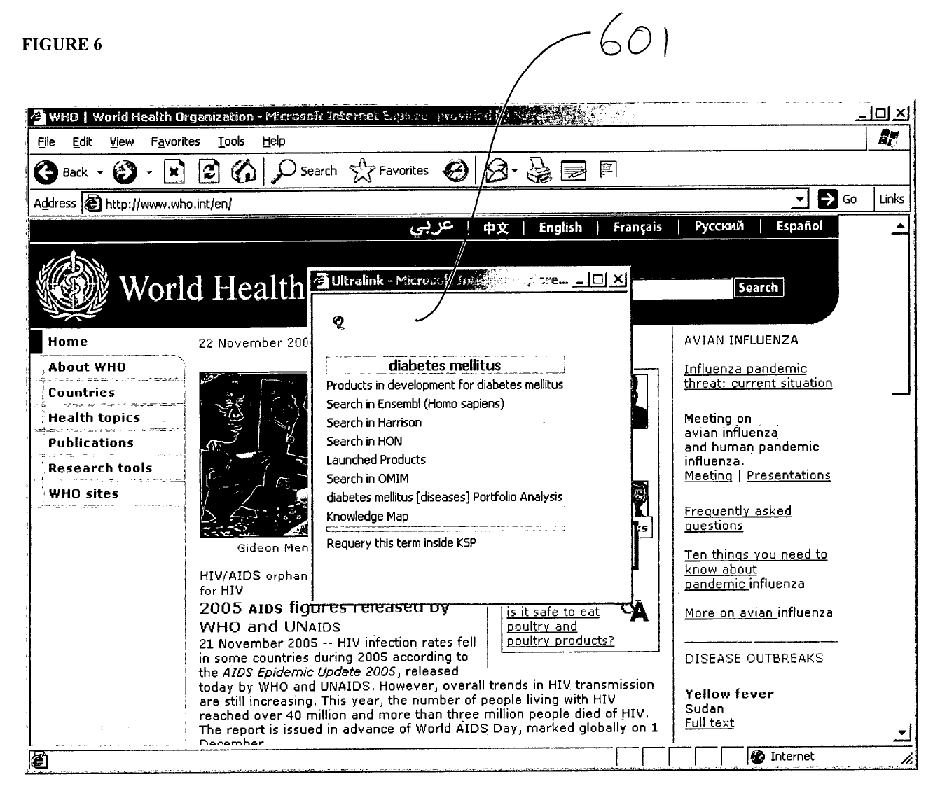

FIG. 6 illustrates the results of the user invocation event for the utility. 601 is a separate window which has appeared providing a list of options for further exploration of the identified word diabetes based on a concept type of the identified word. The word has been identified as corresponding to ‘diabetes mellitus’ from the user-defined library; the options provided are a variety of medical, scientific or commercial inquiries that may be made regarding the word. The user may select the option of greatest interest, or the user may close the window and return to the previous page of text. If the user selects an option, via a user invocation event, the ultralink utility will display the results of the option in a separate window or separate frame of the current window (not shown).

Thus the method of the invention uses five major software components and several elements
1. Service Invocation
2. Extraction, filtering and tagging using text mining techniques
3. Retrieving rules for generating options to be presented via the ultralink
4. Generating the Ultralinks
5. Graphical user interface (Web-based for a Web Browser) and Office based for the implementation within Microsoft Office.
   The Ultralink Uses:

1. a database containing the terminology

2. a database containing rules that drive the behaviour of the UltraLink.

3. configuration files that drive the behaviour of the UltraLink.

The Ultralink may be implemented as a Web service, written in java, and using WSDL. The protocol used to call the service is soap-rpc.

An alternative version of the Ultralink utility is based on a federated service concept. It may also be implemented within standard word processing or text display applications. The “federator UltraLink” connects to “satellite UltraLinks” which in turn access data and connect to applications in a domain specific manner (e.g. bioinformatics, chemoinformatics, medical informatics, etc. . . . ). The federator distributes the requests to a list of selected candidate satellites in parallel and the resulting lists are returned to the federator which consolidates them before sending them back to the user interface. This federator ultralink is an example of the implementation in FIG. 1, 110 where the list of options displayed upon invocation of the ultralink is generated by rules based on the concept type of the identified word.

All methods of the invention may be implemented using standard computer hardware, software and operating environment well know to those skilled in the art.

Hardware and Operating Environment

A brief, general description of a suitable computing environment in which the invention may be implemented is herein provided. The invention may be described in the general context of computer-executable program modules containing instructions executed by a personal computer (PC). Program modules include routines, programs, objects, components, data structures, etc. that perform particular tasks or implement particular abstract data types. Those skilled in the art will appreciate that the invention may be practiced with other computer-system configurations, including hand-held devices, multiprocessor systems, microprocessor-based programmable consumer electronics, network PCs, minicomputers, mainframe computers, and the like which have multimedia capabilities. The invention may also be practiced in distributed computing environments where tasks are performed by remote processing devices linked through a communications network. In a distributed computing environment, program modules may be located in both local and remote memory storage devices.

A general-purpose computing device may be in the form of a conventional personal computer, which includes processing unit, system memory, and system bus that couples the system memory and other system components to the processing unit. The system bus may be any of several types, including a memory bus or memory controller, a peripheral bus, and a local bus, and may use any of a variety of bus structures. The system memory includes read-only memory (ROM) and random-access memory (RAM). A basic input/output system (BIOS), stored in ROM, contains the basic routines that transfer information between components of personal computer. BIOS also contains start-up routines for the system. A personal computer may further include a hard disk drive for reading from and writing to a hard disk, a magnetic disk drive for reading from and writing to a removable magnetic disk, and/or an optical disk drive for reading from and writing to a removable optical disk such as a CD-ROM or other optical medium. The hard disk drive, magnetic disk drive, and/or optical disk drive are connected to the system bus by a hard-disk drive interface, a magnetic-disk drive interface, and/or an optical drive interface, respectively. The drives and their associated computer-readable media provide nonvolatile storage of computer-readable instructions, data structures, program modules and other data for the implementation of the method on the personal computer. Although the exemplary environment described herein employs a hard disk, a removable magnetic disk and a removable optical disk, those skilled in the art will appreciate that other types of computer-readable media which can store data accessible by a computer may also be used in the exemplary operating environment. Such media may include magnetic cassettes, flash-memory cards, digital versatile disks, Bernoulli cartridges, RAMs, ROMs, and the like.

Program modules may be stored on the hard disk, magnetic disk, optical disk, ROM and RAM. Program modules may include the operating system, one or more application programs, other program modules, and program data. A user may enter commands and information into a personal computer through input devices such as a keyboard and a pointing device (often called a mouse). Other input devices may include a microphone, joystick, game pad, satellite dish, scanner, or the like. Another input device is a touch-sensitive screen. A Touch Sensitive Screen is a pointing device that enables the user to interact with the computer by touching the screen. Three common forms of touchscreen are pressure-sensitive, capacitive surface and light beam. Other forms may be developed. These and other input devices are often connected to the processing unit through a serial-port interface coupled to the system bus; but they may be connected through other interfaces, such as a parallel port, a game port, or a universal serial bus (USB). A monitor or other display device also connects to system bus via an interface such as a video adapter. In addition to the monitor, personal computers typically include other peripheral output devices such as speakers and printers.

The personal computer may operate in a networked environment using logical connections to one or more remote computers. A remote computer may be another personal computer, a server, a router, a network PC, a peer device, or other common network node. It typically includes many or all of the components described above in connection with personal computer. The logical connections include local-area network (LAN) and a wide-area network (WAN). Such networking environments are commonplace an offices, enterprise-wide computer networks, intranets and the Internet.

When placed in a LAN networking environment, a PC connects to local network through a network interface or adapter. When used in a WAN networking environment such as the Internet, the PC typically includes a modem or other means for establishing communications over network. A modem may be internal or external to the PC, and connects to the system bus via a serial-port interface. In a networked environment, program modules, such as those comprising Microsoft® Word which reside within the PC or portions thereof may be stored in a remote storage device. Of course, the network connections described are illustrative, and other means of establishing a communications link between the computers may be substituted.

All the steps of the method can be implemented in computer software using programming language well known to those skilled in the art. Software may be designed using many different methods, including object oriented programming methods. C++ and Java are two examples of common object oriented computer programming languages that provide functionality associated with object-oriented programming. Object oriented programming methods provide a means to encapsulate data members (variables) and member functions (methods) that operate on that data into a single entity called a class. Object oriented programming methods also provide a means to create new classes based on existing classes.

An object is an instance of a class. The data members of an object are attributes that are stored inside the computer memory, and the methods are executable computer code that act upon this data, along with potentially providing other services. The notion of an object is exploited in the present invention in that certain aspects of the invention may be implemented as objects in one embodiment.

An interface is a group of related functions that are organized into a named unit. Each interface may be uniquely identified by some identifier. Interfaces have no instantiation, that is, an interface is a definition only without the executable code needed to implement the methods which are specified by the interface. An object may support an interface by providing executable code for the methods specified by the interface. The executable code supplied by the object must comply with the definitions specified by the interface. The object may also provide additional methods. Those skilled in the art will recognize that interfaces are not limited to use in or by an object oriented programming environment.

In an embodiment of the present invention, the ultralink utility may be incorporated as part of the operating system, application programs, or other program modules. The options presented based on concept type may be stored as program data.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

We claim:

1. A computer implemented method for exploring a word in a text comprising:
a) displaying a text on a computer display device,
b) responding to a user invocation event by identifying one or more words which are present in the text, from a user-defined library, thereby generating one or more identified words,
c) associating a utility with each identified word, wherein the utility provides the user with a list of two or more options for further exploration of the identified word based on a concept type associated with the identified word; and
d) displaying the text on the computer display device with the utility in visual association with each identified word.

2. The method of claim 1 wherein the computer display device is a video monitor.

3. The method of claim 1 wherein the user invocation event is selected from among clicking on a request button in a navigation bar, clicking on an icon elsewhere on the computer display device, touching an icon on a touch-sensitive screen, a mouse click, a mouse action, a keyboard input and any combination thereof.

4. The method of claim 1 wherein at least two identified words are generated.

5. The method of claim 1 wherein the user-defined library comprises at least two different words.

6. The method of claim 1 wherein step d) employs placing a visual icon adjacent to the identified word.

7. The method of claim 1 wherein step d) employs textual highlighting of the word.

8. The method of claim 7 wherein a different colour of textual highlighting is employed for identified words of different concept types.

9. The method of claim 1 wherein the list of two or more options is selected from among Search Options and Analytical Options.

10. The method of claim 1 wherein prior to providing the list of two or more options, where there is more than one concept type associated with the identified word, activation of the utility invokes a request to the user to select the concept type.

11. The method of claim 1 wherein the utility displays the list of two or more options in response to a second user invocation event.

12. The method of claim 11 wherein in response to the second user invocation event the utility displays the list of two or more options in a separate window.

13. The method of claim 11 wherein each of the two or more options displayed in response to the second user invocation event may be activated in response to a third user invocation event.

14. The method of claim 13 wherein the results of the option activated by the third user invocation event are displayed in a separate window.

15. The method of claim 1 wherein the computer executes the steps of generating one or more identified words and associating with each identified word a utility by:
sending the text to a lexical analysis server comprising a user-defined library,
wherein the lexical analysis server:
compares each word in the text against the user-defined library,
tags words in the text also found in the user-defined library, to generate tagged words,
returns tagged words to the computer,
receiving the tagged word from the lexical analysis server, and
modifying the text on the computer display device to visually associate the utility with every occurrence of each tagged word.

16. A computer readable medium encoding a computer program for executing on a computer system a computer process for exploring one or more words in a text, the computer process comprising:
a) displaying a text on a computer display device,
b) responding to a user invocation event by identifying one or more words which are present in the text, from a user-defined library, thereby generating one or more identified words,
c) associating a utility with each identified word, wherein the utility provides the user with a list of two or more options for further exploration of the identified word based on a concept type associated with the identified word; and
d) displaying the text on the computer display device with the utility in visual association with each identified word.

17. The computer process encoded by the computer readable medium of claim 16 wherein the computer process comprises displaying a text on a computer display device which is a video monitor.

18. The computer process encoded by the computer readable medium of claim 16 wherein the user invocation event of the computer process is selected from among clicking on a request button in a navigation bar, clicking on an icon elsewhere on the computer display device, touching an icon on a touch-sensitive screen, a mouse click, a mouse action, a keyboard input and any combination thereof.

19. The computer process encoded by the computer readable medium of claim 16 wherein the computer process generates at least two identified words.

20. The computer process encoded by the computer readable medium of claim 16 wherein the computer process identifies at least two different words.

21. The computer process encoded by the computer readable medium of claim 16 wherein the computer process performs the step of visually associating a utility with each identified word by placing a visual icon adjacent to the identified word.

22. The method of claim 16 wherein the step of visually associating a utility with each identified word employs textual highlighting of the word.

23. The method of claim 22 wherein a different colour of textual highlighting is employed for identified words of different concept types.

24. The computer process encoded by the computer readable medium of claim 16 wherein the computer process provides the list of two or more options from among Search Options and Analytical Options.

25. The computer process encoded by the computer readable medium of claim 16 wherein the utility provided by the computer process, prior to providing the list of two or more options, requests the user to select the concept type where there is more than one concept type associated with the identified word.

26. The computer process encoded by the computer readable medium of claim 16 wherein the computer process executes the steps of generating one or more identified words and visually associating with each identified word a utility by:
sending the text to a lexical analysis server comprising a user-defined library,
wherein the lexical analysis server:
compares each word in the text against the user-defined library,
tags words in the text also found in the user-defined library, to generate tagged
words,
returns tagged words to the computer,
receiving the tagged words from the lexical analysis server, and
modifying the text on the computer display device to visually associate the utility with every occurrence of each tagged word.

27. The computer process encoded by the computer readable medium of claim 16 wherein the computer process executes the steps of generating one or more identified words and visually associating with each identified word a utility employing:
means for sending the text to a lexical analysis server means for generating identified words; and
means for presenting the text on a computer display device to visually associate the utility with every occurrence of each identified word,
wherein the utility provides a user with a list of two or more options for further exploration of the identified word based on a concept type associated with the identified word.
